(19) United States
(12) Patent Application Publication
(10) Pub. No.: US 2013/0244608 A1
(43) Pub. Date: Sep. 19, 2013

(54) APPARATUS AND METHOD FOR ENABLING INCOMING PAGES FOLLOWING AN EMERGENCY CALL MADE IN AIRPLANE MODE

(71) Applicants: Ashish Malik, San Diego, CA (US); Satish Babu Guttikonda, Hyderabad (IN); Jagadishwar Neela, Hyderabad (IN)

(72) Inventors: Ashish Malik, San Diego, CA (US); Satish Babu Guttikonda, Hyderabad (IN); Jagadishwar Neela, Hyderabad (IN)

(73) Assignee: Qualcomm Incorporated, San Diego, CA (US)

(21) Appl. No.: 13/607,333

(22) Filed: Sep. 7, 2012

Related U.S. Application Data
(60) Provisional application No. 61/559,697, filed on Nov. 14, 2011.

(51) Int. Cl. H04W 4/22

(52) U.S. Cl. CPC H04W 4/22
USPC 455/404.1

(57) ABSTRACT

Embodiments of the present invention provide devices, methods, and systems for use in emergency call situation. For example, in one embodiment, a mobile wireless device transmits a registration message upon an end of an emergency callback mode, which takes place after an emergency call made while the mobile device is in airplane mode, to ensure that the network is aware of the active status of the mobile device. This way, the user of the mobile device can receive all incoming calls after the cessation of the emergency callback mode, relieving the user of the inconvenience of being unaware of their inability to receive incoming calls. Other aspects, embodiments, and features are also claimed and described.

### CROSS-REFERENCE TO RELATED APPLICATION & PRIORITY CLAIM

This application claims priority to and the benefit of U.S. Provisional Patent Application No. 61/559,697, filed in the United States Patent and Trademark Office on Nov. 14, 2011, the entire content of which is incorporated herein by reference as if fully set forth below and for all applicable purposes.

### TECHNICAL FIELD

Aspects of the present disclosure relate generally to wireless communication systems, and more particularly, to mobile wireless devices, communication components, and stations configured to enable emergency calls while in airplane mode or other less than fully enabled operational modes.

### BACKGROUND

Wireless communication networks are widely deployed to provide various communication services such as telephony, video, data, messaging, broadcasts, and so on. Such networks, which are usually multiple access networks, support communications for multiple users by sharing the available network resources.

In many conventional wireless communication networks, mobile wireless stations are provided with a capability to enter into an airplane mode. Airplane mode refers to an operational mode for a mobile station wherein the mobile station transmits a power down registration message to the network and enters an unregistered state, and turns off its communication interface so as not to interfere with an airplane's communication systems.

Some mobile stations that provide an airplane mode allow a user to make emergency calls, e.g., by dialing 911 or other emergency number, while in airplane mode. In this instance, without undergoing the typical registration with the core network, the mobile station exits the airplane mode, turns on its communication interface, and connects to a nearby base station to make the emergency call. After completing the emergency call, the mobile station typically enters an emergency callback mode, where the user is prohibited from dialing non-emergency calls and the emergency authorities may locate and/or call back the user. Embodiments of the present invention are provisioned to address these and other issues.

### BRIEF SUMMARY OF SOME EMBODIMENTS

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides a method of wireless communication operable at a mobile station. Here, the method includes transmitting a power down registration message to enter an unregistered state, placing an emergency call while in the unregistered state, entering an emergency callback mode upon an end of the emergency call, and transmitting a registration message upon an end of the emergency callback mode.

Another aspect of the disclosure provides a mobile station configured for wireless communication, including means for transmitting a power down registration message to enter an unregistered state, means for placing an emergency call while in the unregistered state, means for entering an emergency callback mode upon an end of the emergency call, and means for transmitting a registration message upon an end of the emergency callback mode.

Another aspect of the disclosure provides a mobile station configured for wireless communication, including at least one processor, a communication interface coupled to the at least one processor, and a memory coupled to the at least one processor. Here, the at least one processor is configured to transmit a power down registration message to enter an unregistered state, to place an emergency call while in the unregistered state, to enter an emergency callback mode upon an end of the emergency call, and to transmit a registration message upon an end of the emergency callback mode.

Another aspect of the disclosure provides a computer program product operable at a mobile station configured for wireless communication, including a computer-readable storage medium having instructions for causing a computer to transmit a power down registration message to enter an unregistered state, instructions for causing a computer to place an emergency call while in the unregistered state, instructions for causing a computer to enter an emergency callback mode upon an end of the emergency call, and instructions for causing a computer to transmit a registration message upon an end of the emergency callback mode.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a hardware implementation for an apparatus employing a processing system according to some embodiments of the present invention.

FIG. 2 is a block diagram conceptually illustrating an example of a telecommunications system according to some embodiments of the present invention.

FIG. 3 is a call flow diagram illustrating one example of a problem case resulting in missed calls at a mobile station according to some embodiments of the present invention.

FIG. 4 is a call flow diagram illustrating an exemplary process for reducing or eliminating the problem case illustrated in FIG. 3 according to some embodiments of the present invention.

FIG. 5 is a flow chart illustrating an exemplary process for a mobile station to transmit a registration message upon an end of an emergency callback mode according to some embodiments of the present invention.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Various aspects of the present disclosure may be configured to address an issue that arises when a mobile station in airplane mode is used to place an emergency call, such as by dialing 911. In this scenario, because the mobile station de-registered with the network when it entered into airplane mode, after the emergency call and the following emergency callback mode are completed, the mobile station may believe that it is suitably connected with the network, but the network may continue to route incoming calls to the mobile station's voice mail. Thus, some aspects of the present disclosure may cause the mobile station to explicitly transmit a registration message at the end of the emergency callback mode.

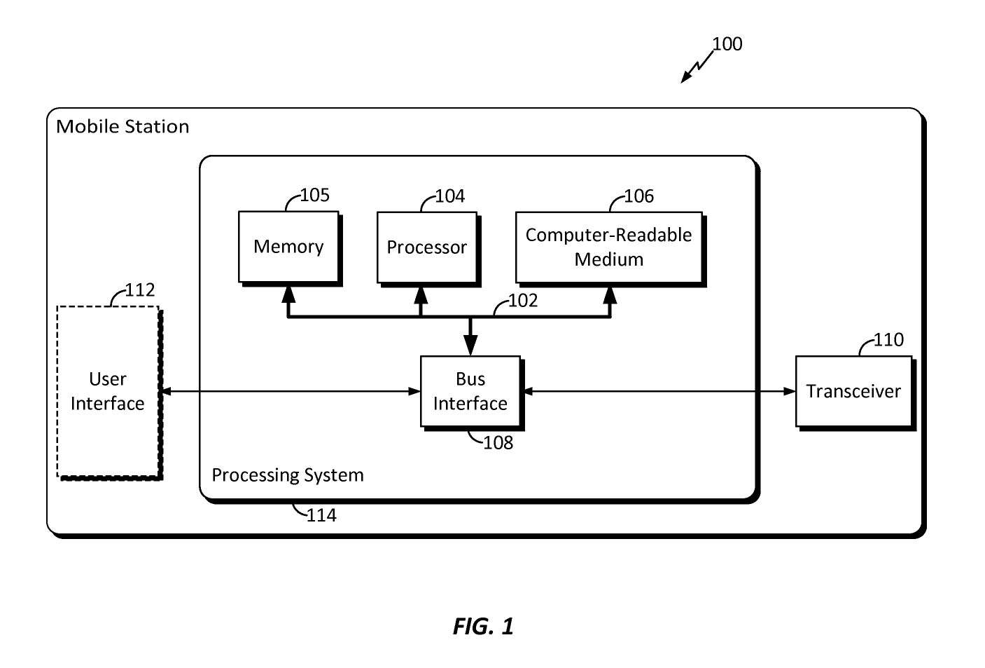

FIG. 1 is a conceptual diagram illustrating an example of a hardware implementation for an apparatus 100 (e.g., a mobile station) employing a processing system 114. In accordance with various aspects of the disclosure, an element, or any portion of an element, or any combination of elements may be implemented with a processing system 114 that includes one or more processors 104. Examples of processors 104 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

In this example, the processing system 114 may be implemented with a bus architecture, represented generally by the bus 102. The bus 102 may include any number of interconnecting buses and bridges depending on the specific application of the processing system 114 and the overall design constraints. The bus 102 links together various circuits including one or more processors (represented generally by the processor 104), a memory 105, and computer-readable media (represented generally by the computer-readable medium 106). The bus 102 may also link various other circuits such as timing sources, peripherals, voltage regulators, and power management circuits, which are well known in the art, and therefore, will not be described any further. A bus interface 108 provides an interface between the bus 102 and a transceiver 110. The transceiver 110 may include one or more transmitters and/or receivers, so as to provide a wired and/or wireless means for communicating with various other apparatus over a transmission medium. Depending upon the nature of the apparatus, a user interface 112 (e.g., keypad, display, speaker, microphone, joystick) may also be provided.

The processor 104 is responsible for managing the bus 102 and general processing, including the execution of software stored on the computer-readable medium 106. The software, when executed by the processor 104, causes the processing system 114 to perform the various functions described infra for any particular apparatus. The computer-readable medium 106 may also be used for storing data that is manipulated by the processor 104 when executing software.

One or more processors 104 in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 106. The computer-readable medium 106 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium 106 may reside in the processing system 114, external to the processing system 114, or distributed across multiple entities including the processing system 114. The computer-readable medium 106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

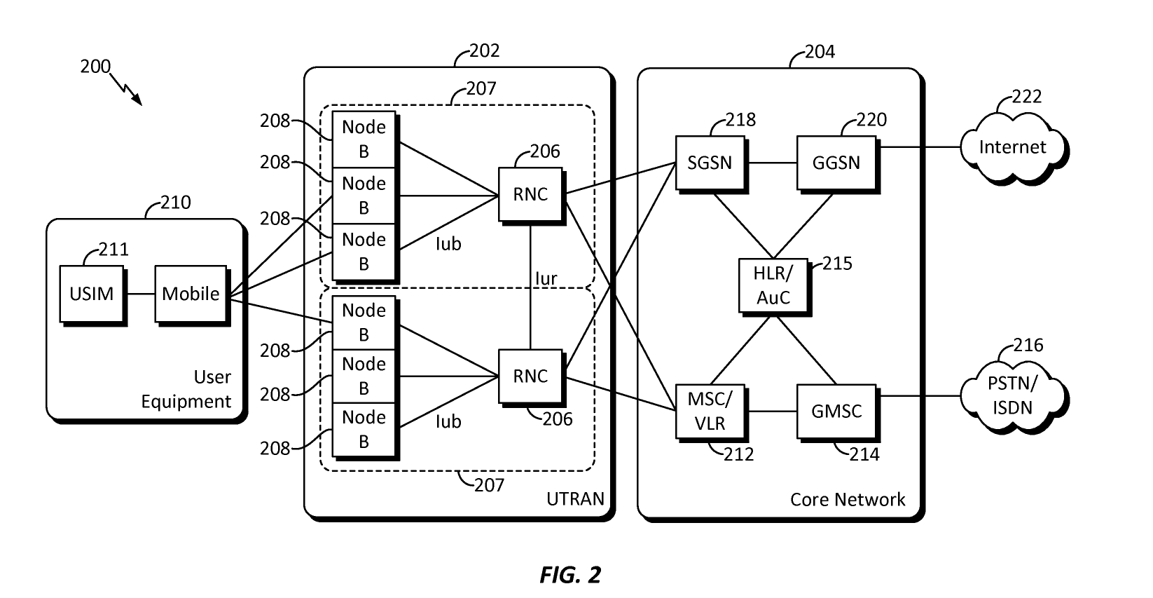

The various concepts presented throughout this disclosure may be implemented across a broad variety of telecommunication systems, network architectures, and communication standards. Referring now to FIG. 2, as an illustrative example without limitation, various aspects of the present disclosure are illustrated with reference to a Universal Mobile Telecommunications System (UMTS) system 200. A UMTS network includes three interacting domains: a core network 204, a radio access network (RAN) (e.g., the UMTS Terrestrial Radio Access Network (UTRAN) 202), and a user equipment (UE) 210. In some examples, the UE 210 may be the same as the mobile station 100; however, within the scope of the present disclosure, any suitable user equipment 210 may be utilized in the system 200.

Among several options available for a UTRAN 202, in this example, the illustrated UTRAN 202 may employ a W-CDMA air interface for enabling various wireless services including telephony, video, data, messaging, broadcasts, and/or other services. The UTRAN 202 may include a plurality of Radio Network Subsystems (RNSs) such as an RNS 207, each controlled by a respective Radio Network Controller (RNC) such as an RNC 206. Here, the UTRAN 202 may include any number of RNCs 206 and RNSs 207 in addition to the illustrated RNCs 206 and RNSs 207. The RNC 206 is an apparatus responsible for, among other things, assigning, reconfiguring, and releasing radio resources within the RNS 207. The RNC 206 may be interconnected to other RNCs (not shown) in the UTRAN 202 through various types of interfaces such as a direct physical connection, a virtual network, or the like using any suitable transport network.

The geographic region covered by the RNS 207 may be divided into a number of cells, with a radio transceiver apparatus serving each cell. A radio transceiver apparatus is commonly referred to as a Node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, three Node Bs 208 are shown in each RNS 207; however, the RNSs 207 may include any number of wireless Node Bs. The Node Bs 208 provide wireless access points to a core network 204 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. In a UMTS system, the UE 210 may further include a universal subscriber identity module (USIM) 211, which contains a user's subscription information to a network. For illustrative purposes, one UE 210 is shown in communication with a number of the Node Bs 208. The downlink (DL), also called the forward link, refers to the communication link from a Node B 208 to a UE 210 and the uplink (UL), also called the reverse link, refers to the communication link from a UE 210 to a Node B 208.

The core network 204 can interface with one or more access networks, such as the UTRAN 202. As shown, the core network 204 is a UMTS core network. However, as those skilled in the art will recognize, the various concepts presented throughout this disclosure may be implemented in a RAN, or other suitable access network, to provide UEs with access to types of core networks other than UMTS networks.

The illustrated UMTS core network 204 includes a circuit-switched (CS) domain and a packet-switched (PS) domain. Some of the circuit-switched elements are a Mobile services Switching Centre (MSC), a Visitor Location Register (VLR), and a Gateway MSC (GMSC). Packet-switched elements include a Serving GPRS Support Node (SGSN) and a Gateway GPRS Support Node (GGSN). Some network elements, like EIR, HLR, VLR, and AuC may be shared by both of the circuit-switched and packet-switched domains.

In the illustrated example, the core network 204 supports circuit-switched services with a MSC 212 and a GMSC 214. In some applications, the GMSC 214 may be referred to as a media gateway (MGW). One or more RNCs, such as the RNC 206, may be connected to the MSC 212. The MSC 212 is an apparatus that controls call setup, call routing, and UE mobility functions. The MSC 212 also includes a visitor location register (VLR) that contains subscriber-related information for the duration that a UE is in the coverage area of the MSC 212. The GMSC 214 provides a gateway through the MSC 212 for the UE to access a circuit-switched network 216. The GMSC 214 includes a home location register (HLR) 215 containing subscriber data, such as the data reflecting the details of the services to which a particular user has subscribed. The HLR is also associated with an authentication center (AuC) that contains subscriber-specific authentication data. When a call is received for a particular UE, the GMSC 214 queries the HLR 215 to determine the UE's location and forwards the call to the particular MSC serving that location.

The illustrated core network 204 also supports packet-switched data services with a serving GPRS support node (SGSN) 218 and a gateway GPRS support node (GGSN) 220. General Packet Radio Service (GPRS) is designed to provide packet-data services at speeds higher than those available with standard circuit-switched data services. The GGSN 220 provides a connection for the UTRAN 202 to a packet-based network 222. The packet-based network 222 may be the Internet, a private data network, or some other suitable packet-based network. The primary function of the GGSN 220 is to provide the UEs 210 with packet-based network connectivity. Data packets may be transferred between the GGSN 220 and the UEs 210 through the SGSN 218, which performs primarily the same functions in the packet-based domain as the MSC 212 performs in the circuit-switched domain.

While the term “airplane mode” referred to in this application connotes a device's limited operation while a user operates the device on an airplane, the term is not so limited and rather intended to have a broader meaning. As mentioned above, airplane mode refers to an operational mode for a mobile station (e.g., user equipment) in a wireless communication system, wherein the mobile station transmits a power down registration message to the network and enters an unregistered state, and turns off its communication interface so as not to interfere with an airplane's communication systems. Similar operational modes for wireless devices may be called offline mode, standalone mode, or any other suitable terminology (e.g., special mode). Again, however, the term airplane mode refers generally to any mode where a communication interface is disabled in a mobile station. For example, airplane mode can include modes where a device is operated at a state less than fully enabled, modes in which one or more communication interfaces are inoperable, and more generally where a device's components (e.g., processor, receiver, transmitter, radio, communications interface) are limited, turned off, or inoperable. In addition, many devices have operating states designed to operate in less than fully enabled states so while embodiments of the present invention may be discussed with mobile stations, other types of components are capable at operating in an airplane mode state (e.g., computers, smartphones, laptops, tablet computers, mobile entertainment devices, and many other devices capable of emitting and receiving wireless signals).

Generally while in an airplane mode, some devices enable an airplane mode allowing a user to make emergency calls, e.g., by dialing 911 or other emergency number. In this instance, without undergoing the typical registration with the core network, the mobile station exits the airplane mode, turns on its communication interface, and connects to a nearby base station to make the emergency call. After completing the emergency call, the mobile station typically enters an emergency callback mode, where the user is prohibited from dialing non-emergency calls and the emergency authorities may locate and/or call back the user.

After a certain period of time, the emergency callback mode ends. Under normal circumstances, the mobile would resume its intended behavior, receiving incoming calls and pages as they are made. However, because the mobile device made the emergency call while in the airplane mode, it is not registered with the network after exiting this mode. Thus, incoming calls may be routed directly to the user's voice mail. Moreover, the user of the mobile device would not know that a call was missed, or that anything out of the ordinary occurred, since the airplane mode is not activated, and the user interface may even incorrectly indicate a connected state, showing bars or other indicator of the signal strength of a nearby base station. This problematic scenario may continue for an extended period of time, or until the user explicitly makes an outgoing call, power cycles the mobile station, enters and subsequently exits the airplane mode, or performs other similar activity to exchange registration messages with the network and register the mobile station.

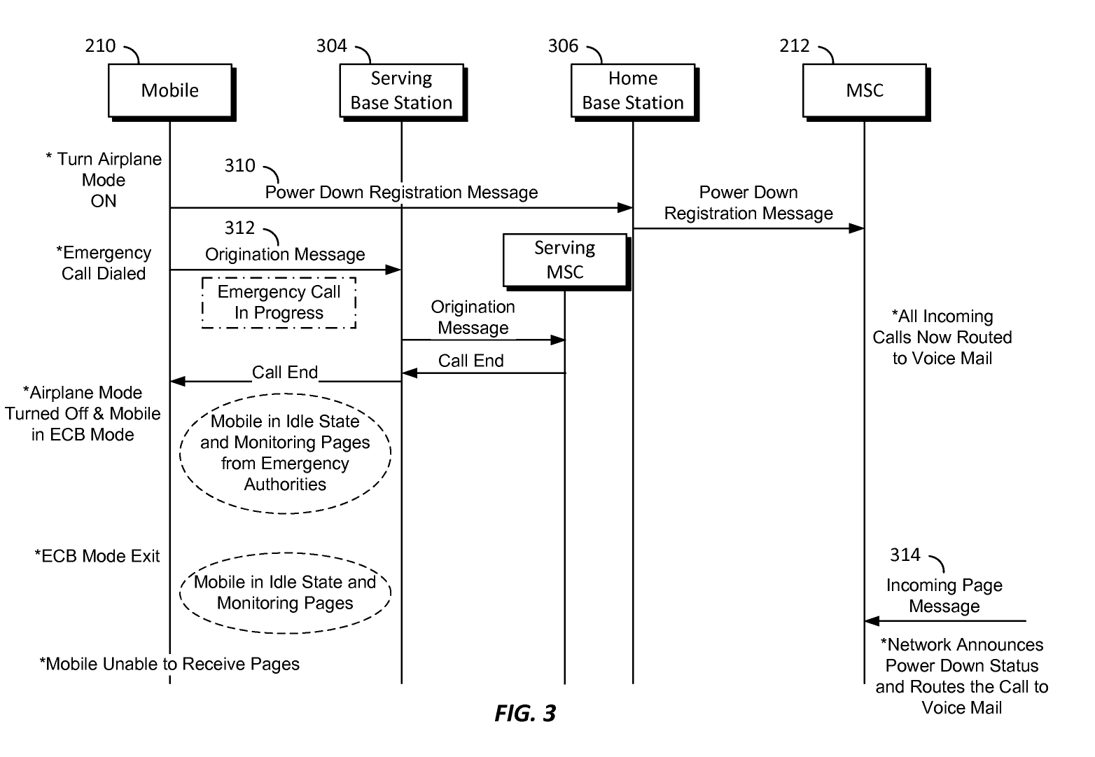

FIG. 3 is a call flow diagram illustrating a problem case as described above in additional detail. In the illustration, a mobile station (e.g., the user equipment 210 described above in relation to FIG. 2, or any other suitable mobile station) may be utilized by a user. The mobile station 210 is initially registered with a core network and served by a home base station 306, managed by a mobile switching center (MSC) 212, as described above in relation to FIG. 2. In accordance with various aspects of the present disclosure, the home base station 306 may be any suitable base station, including but not limited to a macro-cell, a femto-cell, a pico-cell, or some other similar access point components. Moreover, while a single block is shown to represent the home base station 306, this schematic illustration may in fact represent one or more base stations, e.g., when a plurality of base stations simultaneously communicate with the mobile station, or when the mobile station 210 is handed over from one base station to another as its geographic location changes over time.

The user of the mobile station 210 then turns on the airplane mode, at which time the mobile station 210 transmits a power down registration message 310 to the home base station 306, which is thereby forwarded to the MSC 212. In various aspects of the disclosure, the power down registration message 310 may be any suitable message that identifies the mobile station 210 and allows the network to know that the mobile station 210 will not be available to receive future incoming calls or pages. For example, in UMTS, an IMSI Detach Indication may function as a power down registration message. Similarly, in CDMA, a Registration Message, which may include an order qualification as Power Down, may function as a power down registration message.

At this time, the mobile station 210 enters the airplane mode, and radio communication with the network is shut off. However, as described above, some mobile stations still provide functionality for making emergency calls, such as by dialing 911, while the mobile station is in airplane mode. With such a device, the user of the mobile station 210 may dial an emergency number, causing an origination message 312 to be transmitted from the mobile station 210. Any suitable message may be utilized as the origination message 312, including but not limited to a CM service request. Here, the mobile device generally does not prompt the user to explicitly disable the airplane mode, but rather, as far as the user is concerned, the call is completed normally.

The origination message 312 may be received by a base station in a near proximity to the mobile station 210. The base station may then accept the call and become the serving base station 304. In the illustration of FIG. 3, the serving base station 304 is illustrated as a separate block from the home base station 306. However, in some scenarios, e.g., where the mobile station 210 remains in close proximity to the home base station 306, the serving base station 304 may in fact be the same entity as the home base station 306. Of course, in other scenarios the serving base station 304 may in fact be a different entity from the home base station 306.

In any case, the origination message 312 may be utilized to initiate an emergency call. This enables a user to communicate with emergency personnel as needed. At the end of the emergency call, the mobile station 210 may enter into an emergency callback (ECB) mode. Here, as the user awaits further help or direction, while the mobile station 210 remains in the ECB mode, the user may be prohibited from dialing non-emergency calls.

After a certain period of time, the mobile station 210 exits the ECB mode. At this time, the mobile station 210 may remain in an idle state, monitoring for incoming pages or calls. Here, the mobile station 210 may indicate to its user that it is behaving normally, e.g., by showing a signal strength of the serving base station 304, and the user may then believe that no action need be taken to receive incoming calls.

However, because the mobile station 210 previously transmitted the power down registration message 310 and never re-registered with the network, the network may not have sufficient information to direct an incoming page message 314 to the mobile station 210. That is, although the mobile station 210 communicated with the serving base station 304 during the emergency call, registration information indicating which cell the mobile station 210 is located within was not transmitted to the network. Rather, the last information the network received was the Power Down Registration Message 310, and thus, an incoming page message 314 directed to the mobile station 210 is responded to by announcing the power down status of the mobile station 210, and the call is routed to the user's voice mail.

Without user action to register the mobile station 210 with the network, this problem case may remain for a certain period of time, or even potentially indefinitely. To resolve the problem, the mobile station 210 must generally transmit a registration message to register with the network, e.g., by power cycling, by entering and then exiting the airplane mode, by placing an outgoing call, etc.

In accordance with an aspect of the present disclosure, this problem scenario may be reduced or eliminated by configuring the mobile station 210 to transmit a registration message upon an exit from the ECB mode.

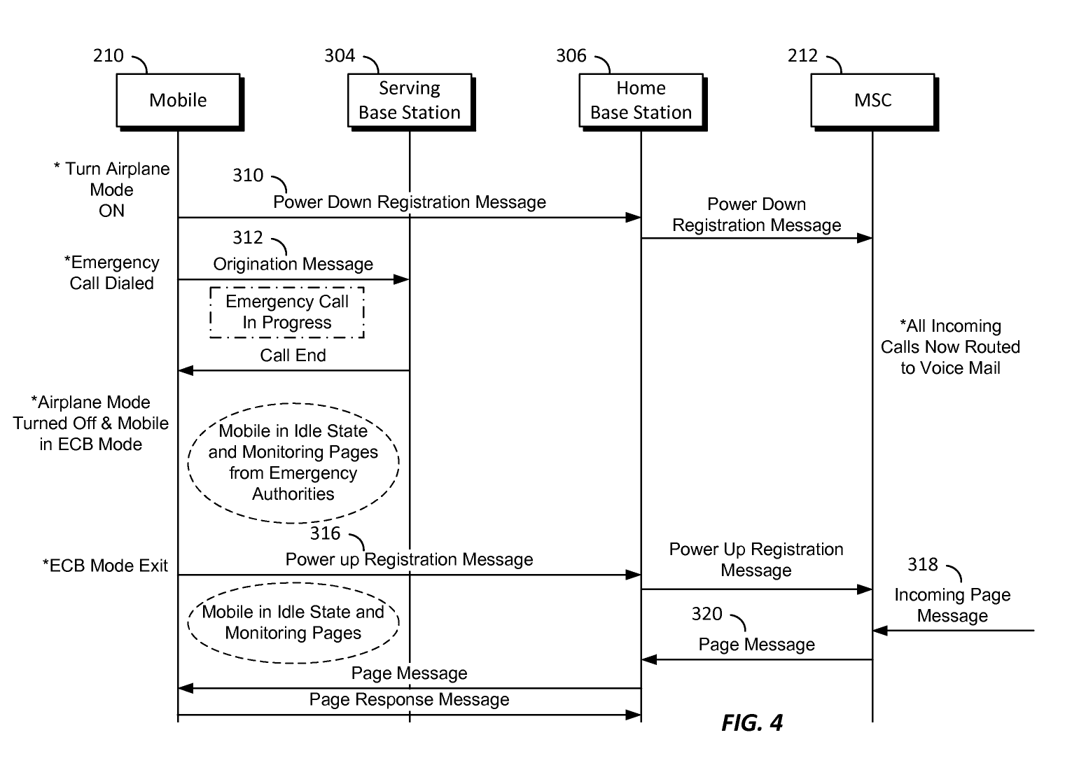

FIG. 4 is a call flow diagram illustrating a process according to one aspect of the present disclosure, wherein the mobile station is configured to transmit the registration message upon exiting the ECB mode. In this illustration, the process is the same as the process illustrated in FIG. 3 up until the mobile station 210 is in the emergency callback mode. Thus, the process up to this point is not described herein in further detail than provided above with respect to FIG. 3.

However, in the illustrated process in FIG. 4, upon exit of the ECB mode, the mobile station 210 may transmit a registration message 316. In various aspects of the present disclosure, the registration message 316 may be any suitable message that identifies the mobile station 210 and enables the network to know the area where the mobile station 210 is located, so that page messages directed to the mobile station 210 may be directed to that area. For example, in UMTS, an IMSI Attach and Location Update Request may function as the registration message 316.

In the illustration, the registration message 316 is transmitted to the home base station 306. In various aspects of the present disclosure, as described above, this may be the same base station as the one to which the Power Down Registration Message 310 was transmitted upon entry into the Airplane Mode. Or it may be a different base station within the scope of the disclosure.

Once the registration message 316 is transmitted from the mobile station 210 to the home base station 306, the mobile station 210 may become registered with the network. This enables incoming calls to be routed to the mobile station 210. For example, by providing information corresponding to the cell in which the mobile station 210 is camped, the MSC 212 may be enabled to forward an incoming page message 318 to the home base station 306 as a page message 320, which may thereafter be transmitted from the home base station 306 to the mobile station 210. In the illustration, the mobile station 210 is shown by transmitting a page response message to the home base station indicating the page message 320 was received.

By configuring the mobile station 210 to transmit the registration message 316 responsive to the exit of the ECB mode following the airplane mode, the user can reduce or eliminate the problem of missing incoming page messages or calls that might otherwise be caused when an emergency call is made by a mobile station in airplane mode.

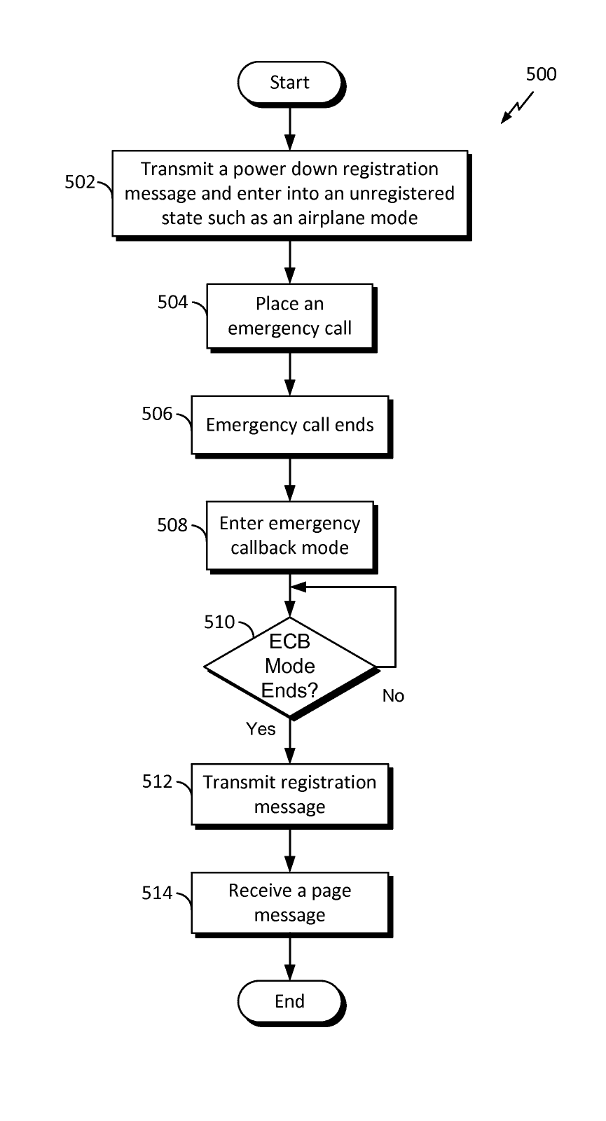

FIG. 5 is a flow chart further illustrating an exemplary process 500 for wireless communication operable at a mobile station (e.g., the mobile station 100 or 210, or any suitable mobile station) according to some aspects of the present disclosure. When the process 500 begins, the mobile station 210 may be communicatively coupled to a wireless network and may be registered with that network, such that incoming page messages may be directed to the mobile station 210. At step 502, the mobile station 210 may transmit a power down registration message to enter an unregistered state. Here, the unregistered state may be the airplane mode, described above, or may be any suitable state for the mobile station 210 wherein an emergency call may be possible although the mobile station 210 is not registered with the network. For example, after powering down and powering up a mobile station, there may be a duration corresponding to a power-up wait timer (e.g., 20 seconds) prior to the transmission of a power up registration message. During this duration, the mobile station may be in the unregistered state; and it may be possible for the mobile station to make an emergency call at this time.

At step 504, the mobile station 210 may place an emergency call while in the unregistered state. For example, the user of the mobile station 210 may dial 911 or any other emergency number, and a call may be established with a nearby base station without registering with the network. At step 506, the emergency call ends, terminating the connection with the nearby base station; and at step 508, the mobile station 210 may enter an emergency callback mode upon the end of the emergency call. The emergency callback (ECB) mode, as described above, may extend for any suitable duration, e.g., a predetermined duration, to enable the emergency personnel to contact the user through the mobile station 210 for any reason such as providing emergency instructions.

At step 510, the mobile station may determine whether the ECB mode has ended. For example, a timer may run to indicate a predetermined duration for the ECB mode; or any suitable indicator such as a signal received from the emergency personnel may explicitly end the ECB mode. If the ECB mode has not ended, then the process may loop back to step 510 until such a time as the ECB mode ends. Upon an end of the ECB mode, at step 512 the mobile station 210 may transmit a registration message. Here, the registration message may be adapted to register the mobile station 210 with the network, to provide the network with information enabling a page message corresponding to an incoming page to be directed to the mobile station 210.

Embodiments of the present invention may have additional features. In some examples, the transmitting of the registration message at step 512 may be configured to occur at the end of each emergency callback mode. In other examples, the transmitting of the registration message at step 512 may be configured to occur only upon an end of an emergency callback mode following an emergency call made while the mobile device 210 was in the unregistered state (e.g., airplane mode).

At step 514, the mobile station 210 may receive a page message corresponding to an incoming page, following the transmitting of the registration message 512. That is, due to the transmission of the registration message 512, as described above, the mobile station need not necessarily miss incoming page messages caused by the making of an emergency call while the mobile station is in airplane mode.

Several aspects of a telecommunications system have been presented with reference to a UMTS system. As those skilled in the art will readily appreciate, various aspects described throughout this disclosure may be extended to other telecommunication systems, network architectures and communication standards.

By way of example, various aspects may be extended to any UMTS system such as W-CDMA, TD-SCDMA and TD-CDMA. Various aspects may also be extended to systems employing Long Term Evolution (LTE) (in FDD, TDD, or both modes), LTE-Advanced (LTE-A) (in FDD, TDD, or both modes), CDMA2000, Evolution-Data Optimized (EV-DO), Ultra Mobile Broadband (UMB), IEEE 802.11 (Wi-Fi), IEEE 802.16 (WiMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

1. A method of wireless communication operable at a mobile station, the method comprising:
transmitting a power down registration message to enter an unregistered state;
placing an emergency call while in the unregistered state;
entering an emergency callback mode upon an end of the emergency call; and
transmitting a registration message upon an end of the emergency callback mode.

2. The method of claim 1, wherein the unregistered state is an airplane mode.

3. The method of claim 1, wherein the transmitting of the registration message is responsive to the ending of the emergency callback mode.

4. The method of claim 1, further comprising:
adapting the registration message to register the mobile station with a network to provide the network with information enabling a page message corresponding to an incoming page to be directed to the mobile station.

5. The method of claim 1, further comprising:
receiving a page message corresponding to an incoming page following the transmitting of the registration message.

6. The method of claim 1, wherein the unregistered state comprises a duration after a power up of the mobile station and prior to a transmission of a power up registration message.

7. A mobile station configured for wireless communication, comprising:
means for transmitting a power down registration message to enter an unregistered state;
means for placing an emergency call while in the unregistered state;
means for entering an emergency callback mode upon an end of the emergency call; and
means for transmitting a registration message upon an end of the emergency callback mode.

8. The mobile station of claim 7, wherein the unregistered state is an airplane mode.

9. The mobile station of claim 7, wherein the means for transmitting the registration message is configured to transmit the registration message responsive to the ending of the emergency callback mode.

10. The mobile station of claim 7, further comprising:
means for adapting the registration message to register the mobile station with a network to provide the network with information enabling a page message corresponding to an incoming page to be directed to the mobile station.

11. The mobile station of claim 7, further comprising:
means for receiving a page message corresponding to an incoming page following the transmitting of the registration message.

12. The mobile station of claim 7, wherein the unregistered state comprises a duration after a power up of the mobile station and prior to a transmission of a power up registration message.

13. A mobile station configured for wireless communication, comprising:
at least one processor;
a communication interface coupled to the at least one processor; and
a memory coupled to the at least one processor,
wherein the at least one processor is configured to:
transmit a power down registration message to enter an unregistered state;
place an emergency call while in the unregistered state;
enter an emergency callback mode upon an end of the emergency call; and
transmit a registration message upon an end of the emergency callback mode.

14. The mobile station of claim 13, wherein the unregistered state is an airplane mode.

15. The mobile station of claim 13, wherein the transmitting of the registration message is responsive to the ending of the emergency callback mode.

16. The mobile station of claim 13, wherein the at least one processor is further configured to:
adapt the registration message to register the mobile station with a network to provide the network with information enabling a page message corresponding to an incoming page to be directed to the mobile station.

17. The mobile station of claim 13, wherein the at least one processor is further configured to:
receive a page message corresponding to an incoming page following the transmitting of the registration message.

18. The mobile station of claim 13, wherein the unregistered state comprises a duration after a power up of the mobile station and prior to a transmission of a power up registration message.

19. A computer program product operable at a mobile station configured for wireless communication, comprising:
a computer-readable storage medium comprising:
instructions for causing a computer to transmit a power down registration message to enter an unregistered state;
instructions for causing a computer to place an emergency call while in the unregistered state;
instructions for causing a computer to enter an emergency callback mode upon an end of the emergency call; and
instructions for causing a computer to transmit a registration message upon an end of the emergency callback mode.

20. The computer program product of claim 19, wherein the unregistered state is an airplane mode.

21. The computer program product of claim 19, wherein the transmitting of the registration message is responsive to the ending of the emergency callback mode.

22. The computer program product of claim 19, wherein the computer-readable storage medium further comprises:
instructions for causing a computer to adapt the registration message to register the mobile station with a network to provide the network with information enabling a page message corresponding to an incoming page to be directed to the mobile station.

23. The computer program product of claim 19, wherein the computer-readable medium further comprises:
instructions for causing a computer to receive a page message corresponding to an incoming page following the transmitting of the registration message.

24. The computer program product of claim 19, wherein the unregistered state comprises a duration after a power up of the mobile station and prior to a transmission of a power up registration message.

25. A communications device configured for operation in multiple states, the device comprising a processor and a communications interface, wherein the processor is configured to:
transmit a first registration message to enter a first state;
place a special call while in the first state;
enter a special callback mode when the special call ends; and
transmit a second registration message the special callback mode ends.

26. A method of wireless communication that includes communicating between the communications device of claim 25 and another wireless communication device.

27. The communications device of claim 25, wherein the first state is one of an airplane mode or a state where one or more interfaces of the communications device is off.
